(19) United States
(12) Patent Application Publication
(10) Pub. No.: US 2024/0249707 A1
(43) Pub. Date: Jul. 25, 2024

(54) ACOUSTIC DEVICE, MUSIC TRACK REPRODUCTION METHOD, AND PROGRAM

(71) Applicant: AlphaTheta Corporation, Yokohama-shi, Kanagawa (JP)

(72) Inventors: Tatsuya Nakagoshi, Yokohama-shi, Kanagawa (JP); Hisashi Kokawa, Yokohama-shi, Kanagawa (JP)

(21) Appl. No.: 18/563,647

(22) PCT Filed: May 27, 2021
(86) PCT No.: PCT/JP2021/020239

§ 371 Date: Nov. 22, 2023

(51) Int. Cl. G10H 1/00; G10H 1/46

(52) U.S. Cl. CPC G10H 1/0025; G10H 1/46; G10H 2210/105; G10H 2210/125

(57) ABSTRACT

There is provided an audio device for playing a music piece, the music piece including a first part and a second part that are acoustically separable from each other, the audio device including: a first playing module configured to play the first part; and a second playing module configured to play, in parallel with playing of the first part, the second part in a first temporal pattern in a first segment of the music piece, and at least one sound included in the second part at a position that is different from a position in the first temporal pattern in a second segment of the music piece.

### TECHNICAL FIELD

The invention relates to an audio device, a method of playing a music piece, and a program.

### BACKGROUND ART

A technique has been known that provides a service by acoustically separating a music piece into multiple parts and using audio data of the separated parts. For example, Patent Literature 1 discloses a technique of arranging predetermined part data out of multiple pieces of part data separated by a music separating means to create arranged part data, and transmitting the arranged part data and original part data in which the predetermined part data is removed from the multiple pieces of part data.

### CITATION LIST

### Patent Literature(s)

Patent Literature 1: JP 2009-186729 A

### SUMMARY OF THE INVENTION

### Problem(s) to be Solved by the Invention

As described above, a technique has been known that acoustically separates a music piece into multiple parts, and processing only a sound of a specific part or cutting a sound of a specific part. An object of the invention is to provide an audio device, a method of playing a music piece, and a program that are not limited to such an example and that provide a new expression using separation of a music piece into parts.

### Means for Solving the Problem(s)

[1] An audio device for playing a music piece, the music piece including a first part and a second part that are acoustically separable from each other, the audio device including: a first playing module configured to play the first part; and a second playing module configured to play, in at least one segment of the music piece and in parallel with playing of the first part, at least one sound included in the second part at a position that is different from a prearranged play position.

[2] The audio device according to [1], further including a selector configured to select the at least one sound from sounds included in the second part.

[3] The audio device according to [1] or [2], in which, in a first segment of the music piece, the second playing module plays the second part in a first temporal pattern, and in a second segment of the music piece, the second playing module plays the at least one sound included in the second part at the position that is different from the prearranged play position, the prearranged play position being based on the first temporal pattern.

[4] The audio device according to [3], in which, in the second segment, the second playing module plays the at least one sound in a second temporal pattern, the second temporal pattern being different from the first temporal pattern.

[5] The audio device according to [4], in which, in a third segment between the first segment and the second segment, the second playing module causes a cross-fade between the at least one sound to be played in the first temporal pattern and the at least one sound to be played in the second temporal pattern.

[6] The audio device according to [5], further including a progression rate setting module configured to set a progression rate of the cross-fade according to an operation amount of an operator, in which a length of the third segment is dynamically determined according to a time variation of the progression rate.

[7] The audio device according to [5] or [6], in which the at least one sound includes a first sound and a second sound, and in the third segment, a cross-fade of the first sound is started at a first time point, and a cross-fade of the second sound is started at a second time point, the second time point being later than the first time point.

[8] The audio device according to any one of [5] to [7], in which, the at least one sound includes a first sound and a second sound, and in the third segment, a cross-fade of the first sound ends at a third time point, and a cross-fade of the second sound ends at a fourth time point, the fourth time point being later than the third time point.

[9] The audio device according to [7] or [8], further including a selecting module configured to individually select the first sound and the second sound from sounds included in the second part.

[10] The audio device according to any one of [1] to [9], in which, the second part includes a drum instrument sound, and the at least one sound includes at least one of a sound of a bass drum, a sound of a snare, or a sound of a hi-hat.

[11] A method of playing a music piece, the music piece including a first part and a second part that are acoustically separable from each other, the method including: playing the first part; and playing, in at least one segment of the music piece and in parallel with playing of the first part, at least one sound included in the second part at a position that is different from a prearranged play position.

[12] A program for causing a computer to operate as an audio device, the audio device for playing a music piece, the music piece including a first part and a second part that are acoustically separable from each other, the audio device including: a first playing module configured to play the first part; and a second playing module configured to play, in at least one segment of the music piece and in parallel with playing of the first part, at least one sound included in the second part at a position that is different from a prearranged play position.

With the configurations described above, while the playing is continued for the first part of the music piece, at least one sound is played at a position that is different from the prearranged play position in at least one segment of the music piece for the second part. Changing the play position without changing the sound included in the second part makes it possible to perform a new expression such as changing only a rhythm pattern of one of the parts or improvising only one of the parts, while the playing of the same music piece is continued.

### BRIEF DESCRIPTION OF THE DRAWINGS

FIG. 1 is a diagram illustrating an overall configuration of an audio device according to one exemplary embodiment of the invention.

FIG. 2 is a block diagram illustrating a configuration of functions included in the audio device illustrated in FIG. 1.

FIG. 3 is a diagram for explaining separation of a music piece and extraction of a unit sound according to one exemplary embodiment of the invention.

FIG. 4 is a diagram for explaining an example of temporal patterns of a part of the music piece.

FIG. 5 is a diagram illustrating a first example in which a play position of a sound included in the part of the music piece is changed according to one exemplary embodiment of the invention.

FIG. 6 is a diagram illustrating a second example in which the play position of the sound included in the part of the music piece is changed according to one exemplary embodiment of the invention.

FIG. 7 is a diagram illustrating a third example in which the play position of the sound included in the part of the music piece is changed according to one exemplary embodiment of the invention.

### DESCRIPTION OF EMBODIMENT(S)

The following describes preferred exemplary embodiments of the invention in detail with reference to the accompanying drawings. It is to be noted that, in this description and the accompanying drawings, components that have substantially the same functional configuration are indicated by the same reference signs, and thus redundant description thereof is omitted.

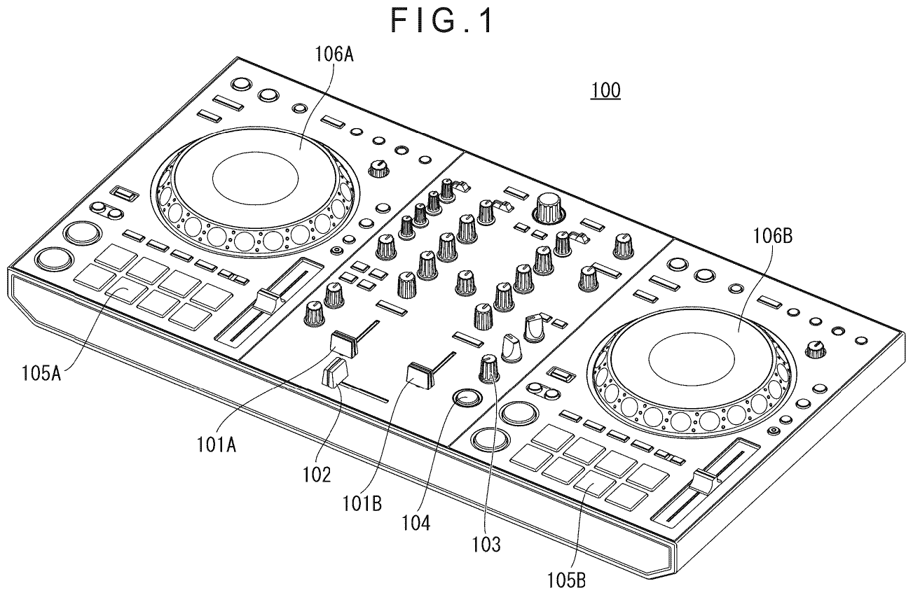

FIG. 1 is a diagram illustrating an overall configuration of an audio device according to an exemplary embodiment of the invention. The audio device according to the exemplary embodiment is a DJ controller 100. The DJ controller 100 plays a music piece using audio data acquired from an outside. In this case, it is possible for a user to add various effects to the playing of the music piece or control the playing by using operators including, for example, channel faders 101A and 101B, a cross fader 102, an effect adjustment knob 103, an effect activation button 104, performance pads 105A and 105B, jog wheels 106A and 106B that are disposed on the DJ controller 100. It is to be noted that the DJ controller 100 is configured similarly to an ordinary DJ controller for portions other than functions to be described below, and thus detailed explanation of these portions is omitted.

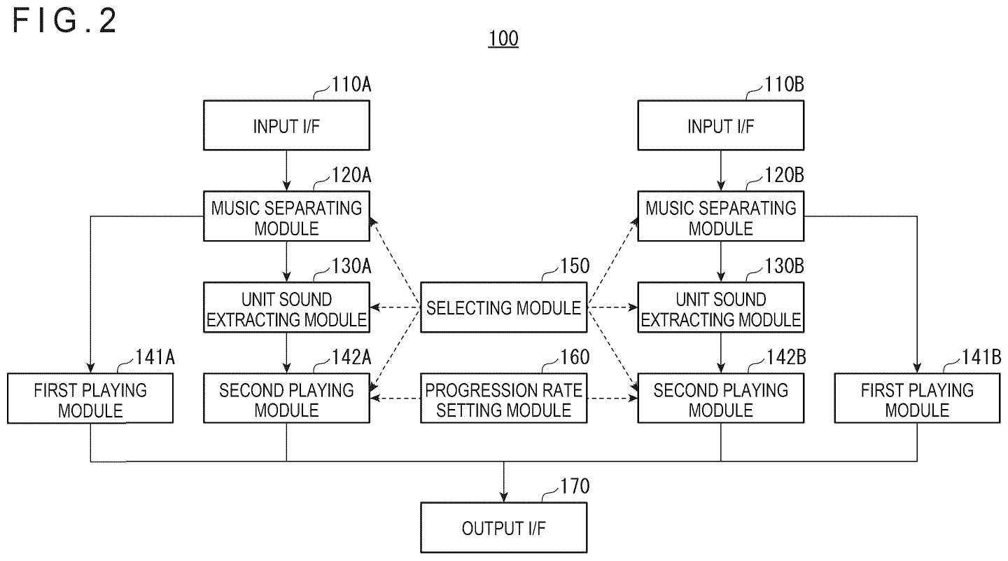

FIG. 2 is a block diagram illustrating a configuration of functions included in the audio device illustrated in FIG. 1. In the illustrated example, the DJ controller 100 includes input interfaces 110A and 110B, music separating modules 120A and 120B, unit sound extracting modules 130A and 130B, first playing modules 141A and 141B, second playing modules 142A and 142B, a selecting module 150, a progression rate setting module 160, and an output interface 170. These components are implemented, for example, by an interface device for an audio signal, and a CPU (Central Processing Unit) or a DSP (Digital Signal Processor) that operates in accordance with a program stored in a memory.

Audio data of the music piece is inputted to each of the input interfaces 110A and 110B from a terminal device such as a PC (Personal Computer) or a smartphone that is coupled to the input interfaces 110A and 110B by a wired or wireless communication means such as a USB (Universal Serial Bus), or from a removable recording medium such as a USB memory. The music separating modules 120A and 120B each acoustically separate the music piece into multiple parts using, for example, a known music separation engine. The unit sound extracting modules 130A and 130B each extract a unit sound for a sound included in at least one of the multiple parts of the music piece separated by corresponding one of the music separating modules 120A and 120B.

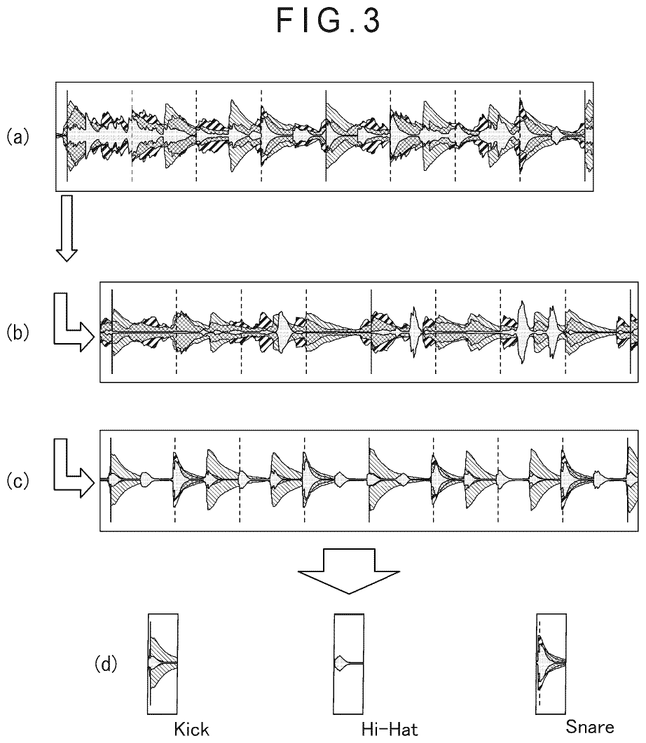

FIG. 3 is a diagram for explaining separation of the music piece and extraction of the unit sound according to an exemplary embodiment of the invention. In an example illustrated in FIG. 3, an audio waveform of the music piece as a whole indicated by (a) is separated into: a non-drum vocal-and-instrument sound part (a first part) indicated by (b); and a drum sound part (a second part) indicated by (c). Further, as indicated by (d), respective unit sounds of a bass drum (Kick), a hi-hat, and a snare that are included in the drum sound part are extracted.

Here, the unit sounds may be extracted by, for example, the music separating modules 120A and 120B separating the drum sound part further into parts of the bass drum, the hi-hat, and the snare, or segmenting the drum sound part into time periods based on acoustic characteristics. Further, the extracted unit sound may be held as audio data sampled from the separated part, or may be held as temporal position information in which the unit sound is to be played in the separated part. Alternatively, the unit sound may be replaced with a sample sound similar to the extracted sound. In this case, the unit sound is held as audio data of the sample sound or as an identifier of the sample sound.

The respective processes of the music separating modules 120A and 120B and the unit sound extracting modules 130A and 130B described above may each be performed, for example, when the audio data of the music piece is loaded via the input interfaces 110A and 110B prior to playing of the music piece, or may be executed earlier than that as an advance preparation for DJ play. When the data of the part or the unit sound of the music piece that is prepared in advance is acquirable via the input interfaces 110A and 110B, the DJ controller 100 may include either of the music separating modules 120A and 120B or the unit sound extracting modules 130A and 130B, or may include neither the music separating modules 120A and 120B nor the unit sound extracting modules 130A and 130B.

In the following explanation, an audio signal processing system including the first playing module 141A and the second playing module 142A is referred to as an A deck, and an audio signal processing system including the first playing module 141A and the second playing module 142A is referred to as a B deck. The A deck and the B deck each play the music piece independently. An audio signal of the music piece played by one of the A deck or the B deck is outputted from the output interface 170 in accordance with an operation of the user. Alternatively, respective audio signals of the music pieces played by the A deck and the B deck are mixed at predetermined rates and are outputted from the output interface 170 in accordance with the operation of the user.

The first playing modules 141A and 141B each play the first part of the music piece, specifically the non-drum vocal-and-instrument sound part. In contrast, the second playing modules 142A and 142B each play the second part of the music piece, specifically the drum sound part, in parallel with the playing of the first part by the first playing modules 141A and 141B. In the exemplary embodiment, the first playing modules 141A and 141B each play the first part of the music piece in an original temporal pattern, i.e., in a state in which a sounding position that is originally defined in the audio data of the music piece is maintained. In contrast, the second playing modules 142A and 142B each play, in a first segment of the music piece, the second part of the music piece in the original temporal pattern, whereas the second playing modules 142A and 142B each play, in a second segment of the music piece, at least one sound included in the second part at a position that is different from a position in the original temporal pattern, as described below.

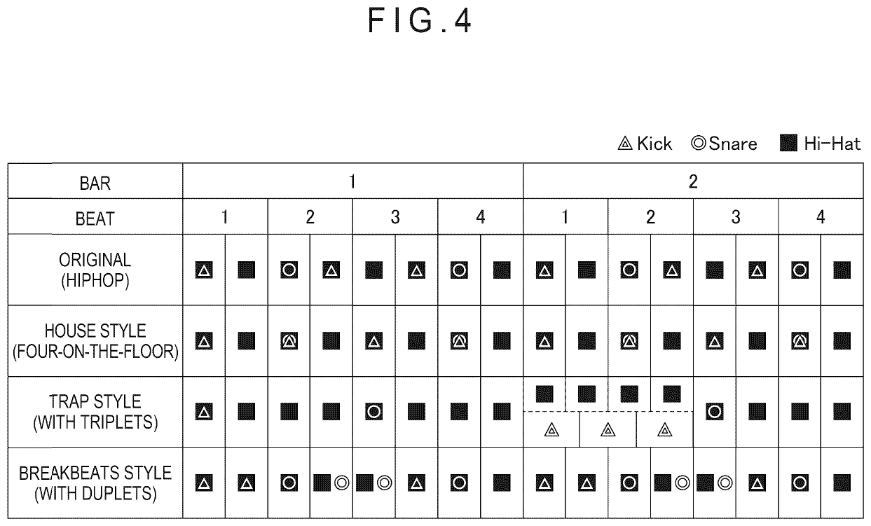

FIG. 4 is a diagram for explaining an example of temporal patterns in the part of the music piece. Herein, a temporal pattern during playing of the part of the music piece is defined by a set of temporal position information at which sounds included in the part are to be played. Specifically, the example illustrated in FIG. 4 indicates, as an original pattern, a temporal pattern in the drum sound part of a hiphop-style music piece. In this pattern, play positions of sounds of the bass drum (Kick), the snare, and the hi-hat that are included in the drum sound part are expressed in terms of eighth note length as follows.

Bass drum=1/4/6 Snare=3/7 Hi-hat=1/2/3/4/5/6/7/8

Similarly, in a temporal pattern in the drum sound part of a house-style music piece illustrated in FIG. 4, the play positions of the respective sounds are as follows.

Bass drum=1/3/5/7 Snare=3/7 Hi-hat=1/2/3/4/5/6/7/8

Further, in a temporal pattern in the drum sound part of a breakbeat-style music piece, the play positions of the respective sounds are as follows.

Bass drum=1/2/6 Snare=3/4.5/5.5/7 Hi-hat=1/2/3/4/5/6/7/8

In contrast, in a trap style, a temporal pattern is in units of two bars, and the play positions of the respective sounds in the first bar are as follows.

Bass drum=1 Snare=5 Hi-hat=1/2/3/4/5/6/7/8

Further, the play positions of the respective sounds in the second bar are as follows.

Bass drum=1/2.33/3.67 Snare=5 Hi-hat=1/2/3/4/5/6/7/8

In the exemplary embodiment, for example, the second playing modules 142A and 142B each play the drum sound part (the second part) in the temporal pattern of the hiphop-style music piece (the first temporal pattern) in the first segment of the music piece, and the drum sound part in the temporal pattern of the house style (the second temporal pattern) in the second segment of the music piece. In this case, as described above in the explanation of the play positions, the play positions of the snare (3/7) and the hi-hat (1/2/3/4/5/6/7/8) do not change between the first segment and the second segment, but the play positions of the bass drum change between the first segment (1/4/6) and the second segment (1/3/5/7). That is, in the case of this example, the sound of the bass drum serving as one sound included in the drum sound part is played in the second segment of the music piece at the position that is different from the position in the temporal pattern in the first segment.

Although FIG. 4 illustrates rhythm patterns each having a length of one bar or two bars, the temporal pattern in the part of the music piece is not limited to such examples. For example, a pattern having a length shorter than one bar may be defined as the temporal pattern, or a pattern having a longer length, for example, the music piece as a whole, may configure the temporal pattern. In this case, the temporal pattern is not necessarily referred to as a rhythm pattern. Further, at least one sound included in the second part in the second segment of the music piece is played at the position that is different from the position in the first temporal pattern. This means that the at least one sound is played at the position that is different from a prearranged play position at which the sound would have been played in the second segment if the music piece were ordinarily played. In the above-described example, the prearranged play position is determined according to the first temporal pattern. In another example of the exemplary embodiment, the second part may be played at a position that is different from the prearranged play position from the beginning of the music piece. That is, in the exemplary embodiment, the second playing modules 142A and 142B each play at least one sound included in the second part at the position that is different from the prearranged play position, in at least one segment of the music piece.

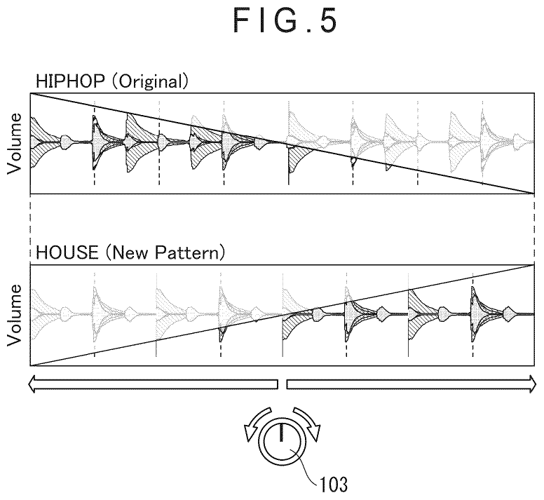

FIG. 5 is a diagram illustrating a first example in which a play position of a sound included in the part of the music piece according to an exemplary embodiment of the invention. In this example, the second playing modules 142A and 142B each play the drum sound part (the second part) in the temporal pattern of the hiphop-style music piece (a first pattern) in the first segment of the music piece, and the drum sound part in the temporal pattern of the house style (a second pattern) in the second segment of the music piece. In a third segment of the music piece between the first segment and the second segment, the second playing modules 142A and 142B each cause a cross-fade between the sounds to be played in the respective temporal patterns. Specifically, for the sound of the bass drum in which the play positions change between the hiphop-style pattern and the house-style pattern as described above, a volume level of the sound played at the positions (1/4/6) of the hiphop-style pattern gradually decreases and a volume level of the sound played at the positions (1/3/5/7) of the house-style pattern gradually increases in the third segment.

Further, in the example illustrated in FIG. 5, the cross-fade between the sound of the first pattern and the sound of the second pattern in the third segment progresses in accordance with rotation of the effect adjustment knob 103 disposed on the DJ controller 100. Specifically, the first segment of the music piece ends and the third segment starts at a time point at which the effect adjustment knob 103 starts to be rotated from a position on the leftmost side, and the cross-fade starts. That is, the volume level of the first pattern starts to decrease from an ordinary volume level, and the volume level of the second pattern starts to increase from 0. This time point serves as an end point of the first segment of the music piece and also as a start point of the third segment of the music piece. The cross-fade progresses as the effect adjustment knob 103 is rotated clockwise, and the cross-fade ends at a time point at which the effect adjustment knob 103 finishes rotating at a position on the rightmost side. That is, the volume level of the first pattern becomes 0, and the volume level of the second pattern reaches the ordinary volume level. This time point serves as an end point of the third segment of the music piece and also as a start point of the second segment of the music piece.

In the above-described example, the progression rate setting module 160 illustrated in FIG. 2 sets a progression rate of the above-described cross-fade according to a rotation amount of the effect adjustment knob 103 that is an operator. A length of the third segment of the music piece in which the cross-fade progresses is dynamically determined according to a time variation of the progression rate. That is, the length of the third segment is decreased if the effect adjustment knob 103 is rotated fast. Further, the length of the third segment is increased if the effect adjustment knob 103 is rotated slowly or paused in the middle. When the effect adjustment knob 103 is rotated in a reverse direction, i.e., counterclockwise in the example of FIG. 5, the progression rate setting module 160 may decrease the progression rate of the cross-fade. Further, as described above, the time point at which the effect adjustment knob 103 starts to be rotated serves as the end point of the first segment and the start point of the third segment, and the time point at which the effect adjustment knob 103 finishes rotating serves as the end point of the third segment and the start point of the second segment. Accordingly, the start points and the end points of the respective segments of the music piece are dynamically set in the above-described example.

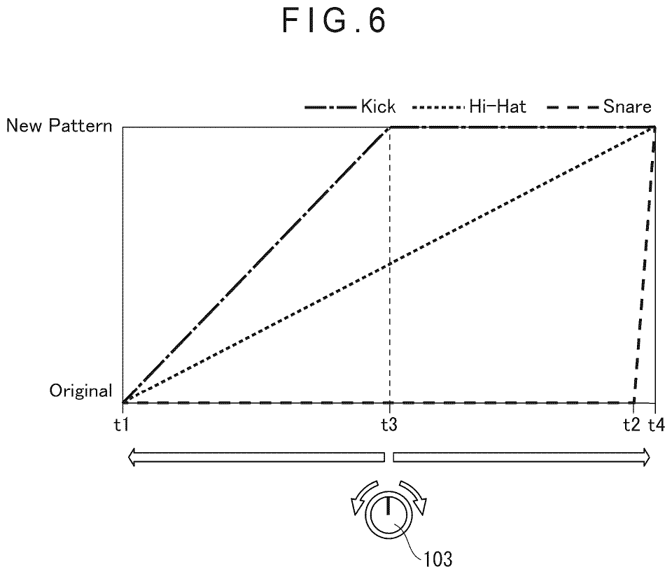

FIG. 6 is a diagram illustrating a second example in which the play position of the sound included in the part of the music piece is changed according to an exemplary embodiment of the invention. In this example, the second playing modules 142A and 142B each play the drum sound part in the first pattern (ORIGINAL) in the first segment of the music piece, and play the drum sound part in the second pattern (NEW PATTERN) in the second segment of the music piece. Between the first pattern and the second pattern, the play positions of all sounds of the bass drum (Kick), the snare, and the hi-hat included in the drum sound part are changed. In the illustrated example, the cross-fade of the sound of the bass drum and the cross-fade of the sound of the hi-hat start at a time point t1 at which the effect adjustment knob 103 starts to be rotated from the position on the leftmost side. The time point t1 serves as the end point of the first segment of the music piece and also as the start point of the third segment of the music piece. The progression rate of the cross-fade to be set with respect to the rotation amount of the effect adjustment knob 103 is greater in the bass drum than in the hi-hat. The cross-fade of the sound of the bass drum ends at a time point t3 at which the effect adjustment knob 103 is rotated to an intermediate position. Thereafter, the cross-fade of the sound of the hi-hat ends at a time point t4 at which the effect adjustment knob 103 finishes rotating at the position on the rightmost side.

In contrast, the cross-fade of the sound of the snare starts at a time point t2. The time point t2 is later than the time point t1 at which the cross-fades of the other two sounds are started. The progression rate of the cross-fade to be set with respect to the rotation amount of the effect adjustment knob 103 is greater in the snare than in the other two sounds. The cross-fade of the sound of the snare ends, as with the sound of the hi-hat, at the time point t4 at which the effect adjustment knob 103 finishes rotating at the position on the rightmost side. The time point t4 serves as the end point of the third segment of the music piece and also as the start point of the second segment of the music piece. According to the above-described cross-fade pattern, the sound of the hi-hat changes relatively slowly from the first pattern to the second pattern throughout the third segment, whereas the sound of the bass drum changes relatively fast and the sound of the snare changes all at once in the last section of the third segment. In this manner, for example, the start time point, the end time point, and the progression rate of the cross-fade may be changed according to characteristics of the respective sounds included in the drum sound part. This makes it possible to reduce a sense of discomfort in pattern change of the drum sound felt by a listener, or conversely, to direct the listener's attention to the pattern change with use of a moderate sense of discomfort.

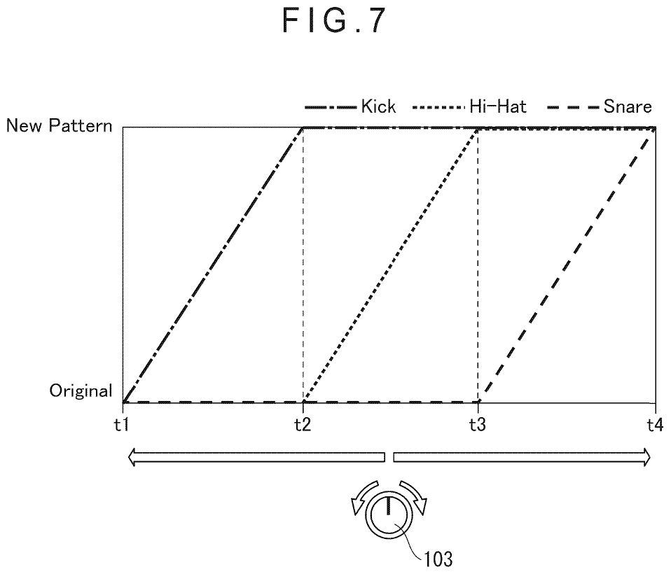

FIG. 7 is a diagram illustrating a third example in which the play position of the sound included in the part of the music piece is changed according to an exemplary embodiment of the invention. In this example also, the second playing modules 142A and 142B each play the drum sound part in the first pattern (ORIGINAL) in the first segment of the music piece, and play the drum sound part in the second pattern (NEW PATTERN) in the second segment of the music piece. Between the first pattern and the second pattern, the play positions of all sounds of the bass drum (Kick), the snare, and the hi-hat included in the drum sound part are changed. In the illustrated example, the cross-fade of the sound of the bass drum starts at the time point t1 at which the effect adjustment knob 103 starts to be rotated from the position on the leftmost side. The time point t1 serves as the end point of the first segment of the music piece and also as the start point of the third segment of the music piece. Along with the rotation of the effect adjustment knob 103, the cross-fade of the sound of the bass drum progresses. Thereafter, at the time point t2 at which the cross-fade of the sound of the bass drum ends, the cross-fade of the sound of the hi-hat starts. Similarly, the cross-fade of the sound of the hi-hat starts at the time point t3 at which the cross-fade of the snare ends. Thereafter, the cross-fade of the sound of the hi-hat ends at the time point t4. The time point t4 serves as the end point of the third segment of the music piece and also as the start point of the second segment of the music piece.

According to the above-described cross-fade pattern, the play positions of the respective sounds included in the drum sound part sequentially change from the first pattern to the second pattern. This makes it possible to reduce audible randomness caused by multiple sounds being simultaneously cross-faded. It is to be noted that, in the illustrated example, the third segment of the music piece is divided into three equal segments, and the cross-fade of the sound of the bass drum, the cross-fade of the sound of the hi-hat, and the cross-fade of the sound of the snare progress in the respective equally divided segments at the same progression rate. However, the third segment may be divided unevenly, and the cross-fades of the respective sounds may progress at different progression rates with respect to the rotation of the effect adjustment knob 103 as with the example illustrated in FIG. 6, for example.

It is to be noted that, in the above-described example, the cross-fades of the three sounds included in the drum sound part progress by rotating the effect adjustment knob 103 that is a single operator; however, when cross-fades of two or more sounds are to be performed, different operators may be allocated to the respective sounds, and the cross-fades may be individually progressed by operating the respective operators. Further, when changing the play positions of two or more sounds from the first pattern to the second pattern, one or more of the sounds may be cross-faded, whereas the other sound(s) may be switched in the pattern immediately, for example, at the start point or the end point of the third segment, without being cross-faded.

For example, in the examples of FIG. 6 and FIG. 7 described above, which sounds that are included in the drum sound part are to be cross-faded in what order or in what progression rate may be set by the selecting module 150 illustrated in FIG. 2, for example, in accordance with an operation of the user on the DJ controller 100. In this case, the selecting module 150 individually selects, for example, a first sound whose cross-fade starts at a first time point t1 in the third segment of the music piece, and a second sound whose cross-fade starts at a second time point t2 in the third segment of the music piece. The second time point t2 is later than the first time point t1. Further, the selecting module 150 individually selects, for example, the first sound whose cross-fade ends at a third time point t3 in the third segment of the music piece, and the second sound whose cross-fade ends at a fourth time point t4 in the third segment of the music piece. The fourth time point t4 is later than the third time point t3. Further, the selecting module 150 may select, for example, out of the sounds included in the drum sound part, a sound to be played in the second segment of the music piece at a temporal position that is different from the temporal position in the first segment. The selection may be performed in accordance with the operation of the user on the DJ controller 100.

According to the above-described examples, the playing of the non-drum sound part (the first part) of the music piece is continued through the first segment and the second segment of the music piece, whereas the playing of the drum sound part (the second part) is performed in such a manner that at least one sound is played in the second segment of the music piece in a rhythm pattern that is different from a rhythm pattern in the first segment of the music piece. Changing the rhythm pattern without changing the sound included in the second part makes it possible to perform genre bending that changes the genre of the music piece while continuing the playing of the same music piece. Specifically, for example, in the example of FIG. 5, the genre bending is performed from the hip-hop to the house. Performing the genre bending within the same music piece allows for genre bending that is reduced in the sense of discomfort as compared with, for example, mixing of two music pieces. Further, it is possible to perform the genre bending using only one of the A deck and the B deck of DJ controller as illustrated in FIG. 1 and FIG. 2, which makes it possible for the other deck to perform an operation such as loading of the next music piece or scratching of another music piece.

It is to be noted that the exemplary embodiment of the invention described above is an example, and is modifiable in various ways. For example, although the DJ controller is exemplified as the audio device in the above-described exemplary embodiment, it is possible for another DJ device such as a mixer or an all-in-one DJ system (a digital audio player with communication and mixing functions) to implement similar functions. It is also possible for a terminal device such as a PC or a smartphone to implement the above-described functions by a DJ application. In these cases, the first playing module and the second playing module described above may not necessarily be implemented inside the terminal device, the first playing module and the second playing module may be implemented in a server that transmits audio data to the terminal device via a network, and the server may function as the audio device. It is to be noted that it is not necessary to play two music pieces at the same time as described above, and the audio device is thus not limited to that which plays music pieces by multiple decks.

Further, in the above exemplary embodiment, the description is given of the case where the first part of the music piece is the non-drum sound part and the second part of the music piece is the drum sound part. However, it is not limited how to allocate separated part of vocal and instrument sounds to the first and second part. For example, the first part may be a part of the vocal sound, and the second part may be a non-vocal sound part.

In the above exemplary embodiment, the description is given of the case where the second part is changed from the first temporal pattern to the second temporal pattern. However, the play position of the sound of the second part in the second segment may not be in accordance with a specific pattern. For example, the above-described unit sound that is extracted by each of the unit sound extracting modules 130A and 130B or the unit sound that is prepared in advance is allocated to each of the performance pads 105A and 105B of the DJ controller 100, and the user may improvise a sound of the second part by operating each of the performance pads 105A and 105B. In this case also, the play position of the sound of the second part in the second segment is different from the prearranged play position that is determined according to the temporal pattern in the first segment. In other cases, the sound of the second part may be improvised from the beginning of the music piece.

In the above exemplary embodiment, the description is given of the case where the change in the play position of the second part is executed by the operation of the effect adjustment knob 103 included in the DJ controller 100. However, the operator for executing the change in play position is not limited to the effect adjustment knob 103, and may be other operators including, without limitation, the channel faders 101A and 101B and the effect activation button 104. Further, the change in the play position of the second part does not necessarily have to be accompanied by the cross-fade in the third segment of the music piece, and for example, the temporal pattern of the second part may be immediately changed by pressing the effect activation button 104. In this case, the third segment is not present in the music piece. Further, also when the sound of the second part is to be improvised in the second segment of the music piece as described above, the change in the play position of the second part is not accompanied by the cross-fade, and the third segment is thus not present in the music piece.

Preferred exemplary embodiments of the invention have been described above in detail with reference to the accompanying drawings, but the invention is not limited to such exemplary embodiments. It is apparent that a person having ordinary skill in the art of the invention can arrive at various alterations and modifications within the scope of the technical idea recited in the appended claims, and it is understood that such alterations and modifications naturally fall within the technical scope of the invention.

### EXPLANATION OF CODES

100: DJ controller, 101A, 101B: channel fader, 102: cross fader, 103: effect adjustment knob, 104: effect activation button, 105A, 105B: performance pad, 106A, 106B: jog wheel, 110A, 110B: input interface, 120A, 120B: music separating module, 130A, 130B: unit sound extracting module, 141A, 141B: first playing module, 142A, 142B: second playing module, 150: selecting module, 160: progression rate setting module, 170: output interface.

1. An audio device for playing a music piece, the music piece comprising a first part and a second part that are acoustically separable from each other, the audio device comprising:
a first playing module configured to play the first part; and
a second playing module configured to play, in at least one segment of the music piece and in parallel with playing of the first part, at least one sound included in the second part at a position that is different from a prearranged play position.

2. The audio device according to claim 1, further comprising a selecting module configured to select the at least one sound from sounds included in the second part.

3. The audio device according to claim 1, wherein, in a first segment of the music piece, the second playing module plays the second part in a first temporal pattern, and in a second segment of the music piece, the second playing module plays the at least one sound included in the second part at the position that is different from the prearranged play position, the prearranged play position being based on the first temporal pattern.

4. The audio device according to claim 3, wherein, in the second segment, the second playing module plays the at least one sound in a second temporal pattern, the second temporal pattern being different from the first temporal pattern.

5. The audio device according to claim 4, wherein, in a third segment between the first segment and the second segment, the second playing module causes a cross-fade between the at least one sound to be played in the first temporal pattern and the at least one sound to be played in the second temporal pattern.

6. The audio device according to claim 5, further comprising a progression rate setting module configured to set a progression rate of the cross-fade according to an operation amount of an operator, wherein
a length of the third segment is dynamically determined according to a time variation of the progression rate.

7. The audio device according to claim 5, wherein
the at least one sound comprises a first sound and a second sound, and
in the third segment, a cross-fade of the first sound is started at a first time point, and a cross-fade of the second sound is started at a second time point, the second time point being later than the first time point.

8. The audio device according to claim 5, wherein
the at least one sound comprises a first sound and a second sound, and
in the third segment, a cross-fade of the first sound ends at a third time point, and a cross-fade of the second sound ends at a fourth time point, the fourth time point being later than the third time point.

9. The audio device according to claim 7, further comprising
a selecting module configured to individually select the first sound and the second sound from sounds comprised in the second part.

10. The audio device according to claim 1, wherein
the second part comprises a drum instrument sound, and
the at least one sound comprises at least one of a sound of a bass drum, a sound of a snare, or a sound of a hi-hat.

11. A method of playing a music piece, the music piece comprising a first part and a second part that are acoustically separable from each other, the method comprising:
playing the first part; and
playing, in at least one segment of the music piece and in parallel with playing of the first part, at least one sound comprised in the second part at a position that is different from a prearranged play position.

12. A non-transitory tangible recording medium recording a program for causing a computer to operate as an audio device, the audio device for playing a music piece, the music piece comprising a first part and a second part that are acoustically separable from each other, the audio device comprising:
a first playing module configured to play the first part; and
a second playing module configured to play, in at least one segment of the music piece and in parallel with playing of the first part, at least one sound included in the second part at a position that is different from a prearranged play position.
